(19) United States
(12) Patent Application Publication
(10) Pub. No.: US 2005/0115939 A1
(43) Pub. Date: Jun. 2, 2005

(54) Method and apparatus for drilling a large number of precision holes with a laser

(75) Inventor: Paul Francis Jacobs, Saunderstown, RI (US)

Correspondence Address: Mr. Clifford G. Brockmyer, Sr.;Laser Fare, Inc.,, One Industrial Drive South, Smithfield, RI, 02917, US

(73) Assignee: Laser Fare, Inc.

(21) Appl. No.: 11/000,860

(22) Filed: Dec. 1, 2004

Related U.S. Application Data
(60) Provisional application No. 60/525,674, filed on Dec. 1, 2003.

(51) Int. Cl. B23K 26/067; B23K 26/38

(52) U.S. Cl. 219/121.77; 219/121.7

(57) ABSTRACT

A laser beam is generated, having a irradiance level sufficient to be divided, is transmitted through a beam splitter that optically processes the beam to divide it into multiple beams having a predetermined irradiance. The multiple beams are further optically transformed to provide an annular irradiance distribution. The annular beams are applied to a target to perform a drilling operation.

### RELATED APPLICATION

This application is a conversion of and claims priority from U.S. Provisional Patent Application No. 60/525,674, filed Dec. 1, 2003.

### BACKGROUND OF THE INVENTION

1. Field of the Invention

This application relates to laser drilling a large number of precision holes. More particularly a method and apparatus is constructed to generate multiple laser beams, each being optically processed to form a narrow annular shaped beam for use in precision drilling small holes.

2. Brief Description of Related Developments

Laser beams have been used to drill holes for years. Because of the ability to focus a laser beam to a small spot, hole diameters less than 200 micrometers may be obtained without concern for breaking, dulling, or wearing out the very tiny, fragile drill bits. In addition, with sufficient irradiance incident on the target, any material may be drilled regardless of its hardness. Even diamonds have been drilled successfully with a laser beam.

Two methods are employed when using a laser beam to drill a hole. The first of these is referred to as percussion drilling. Here a laser beam is focused to a diameter roughly equal to, or slightly smaller than the diameter of the desired hole. Next, the laser is pulsed sufficiently many times to either drill a through hole, extending all the way through the subject material, or a blind hole which extends partly into the subject material, to a pre-specified depth. The primary advantage of laser percussion drilling is speed. A secondary advantage may be that this is often the only means of drilling holes with diameters less than 50 micrometers. However, the disadvantage of laser percussion drilling is that the resulting hole is often less precise than desired. Percussion laser drilled holes are subject to significant taper, eccentricity, hole-to-hole diameter variance, heat affected zone, or “HAZ”, and the accumulation of recast material at or near the hole entrance and exit. This recast involves material melted and often vaporized by the laser beam that either flows to, or condenses upon the surrounding surface, or the entrance and or exit surfaces of the hole.

The second method of laser drilling holes is known as trepanning. Here, a larger diameter hole is drilled using a series of overlapping smaller diameter holes arranged to be internally tangent to the perimeter of the larger hole. Conventional or “mechanical” trepanning may be accomplished by either moving the work-piece while keeping the laser beam fixed, or by moving the laser beam while keeping the work-piece fixed. An important advantage of trepanning is that it generally produces a higher quality hole with greater precision than percussion drilling, especially reducing diameter variance from hole to hole, taper, HAZ, and the extent of recast material. One disadvantage of trepanning is that in most cases it is significantly slower than percussion drilling. A second disadvantage is that it requires either a precise and expensive mechanical X-Y motion system to accurately position and move the substrate, or an equally precise and expensive galvanometer driven set of orthogonal mirrors to deflect sequential laser pulses in the desired final hole configuration. Another disadvantage is the need to program the trepanning motion itself.

In applications where it is necessary to drill thousands up to many millions of small holes to precise tolerances, neither of the above methods fills the current need. It is a purpose of this invention to increase the speed of laser drilling by the trepanning method, while also significantly reducing the need for mechanical movement of the target or laser system.

It has been found that, in general it is desirable to employ an optimum level of irradiance for a specific substrate material. If the local irradiance is below optimum, the hole will retain precision at the expense of extended laser drilling time. Conversely, if the local irradiance is significantly above optimum, the laser drilling time will be brief, but the precision of the drilling process will suffer, especially with respect to the accumulation of excessive recast material and an expanded HAZ. Thus, for a specific material, there exists an optimum local irradiance level (i.e. watts of incident laser power per square centimeter) that will produce the simultaneous combination of good hole-quality and high speed at optimum irradiance levels.

It has also been found that production lasers sufficiently rugged for “shop floor” applications are very expensive, and can often create local irradiance levels well in excess of the optimum value for a specific material. It is a purpose of this invention to obtain a laser beam array by optically processing a laser beam to obtain multiple beams, each capable of drilling precise holes.

### SUMMARY OF THE INVENTION

In the system according to this invention, an optical beam-splitter sub-system is employed to generate multiple laser beams, each possessing sufficient irradiance to efficiently and optimally drill the desired hole. In this manner multiple beams are obtained, while avoiding the cost of multiple laser generating systems, thereby increasing production laser hole drilling speed in a cost effective manner.

To avoid the need for a system to precisely control the motion of either the work-piece or the laser beam to achieve trepanning with the required precision, a further optical subsystem is constructed to accomplish the equivalent of multiple small holes applied in trepanning.

In one embodiment of the invention this is accomplished by constructing an optical trepanning sub-system (“OT-SS”) to process each of the output beams of the optical beam-splitter sub-system. Rather than focusing the laser beam to a tiny circular spot, and then scanning this spot around in a larger circular path, to generate a cylindrical hole via conventional mechanical trepanning, special optics in the OT-SS are employed to generate a narrow annular shaped irradiance distribution. The outer diameter of the annular irradiance distribution would be adjusted to be equal to, or slightly smaller than the desired hole-diameter. Each of the split beams are then transmitted to an optical trepanning sub-system where they are formed into the correct annular irradiance distribution through specialized and adjustable optics.

The resultant annular output beam, when directed onto the target material would operate in a manner substantially similar to conventional mechanical laser trepanning. However, this action would be accomplished without the need for any motion of either the substrate or the laser beam. In this manner the system of this invention would provide superior long-term reliability and precision.

The use of an optical beam splitter to obtain multiple beams which are each individually optically processed to generate a hole-drilling beam of annular form will enable retention of the precision advantages of trepanning, with the speed advantages associated with drilling multiple holes simultaneously, while avoiding the long-term effects of reduced precision associated with repetitive motion over thousands to millions of cycles.

In another feature of this invention, Argon gas is also concurrently introduced through a nozzle that is positioned directly in line with the hole. Argon is an inert gas, and hence will not promote any chemical reaction with the material being drilled. Also, with proper adjustment of the nozzle to create the correct flow velocity, this technique can also reduce the amount of recast material condensing on the side-walls of the hole.

### DESCRIPTION OF THE DRAWING

The system of this invention is described in more detail below with reference to the drawing attached hereto in which:

FIG. 1 is block diagram of the laser drilling system of this invention;

FIG. 2 is a schematic diagram of a nozzle configuration through which the laser is applied to a target according to this invention;

FIG. 3 is an illustration of the irradiance pattern of a laser beam generated by the system of FIG. 1; and

FIG. 4 is a schematic diagram of optical processor as shown in FIG. 1.

### DETAILED DESCRIPTION OF THE INVENTION

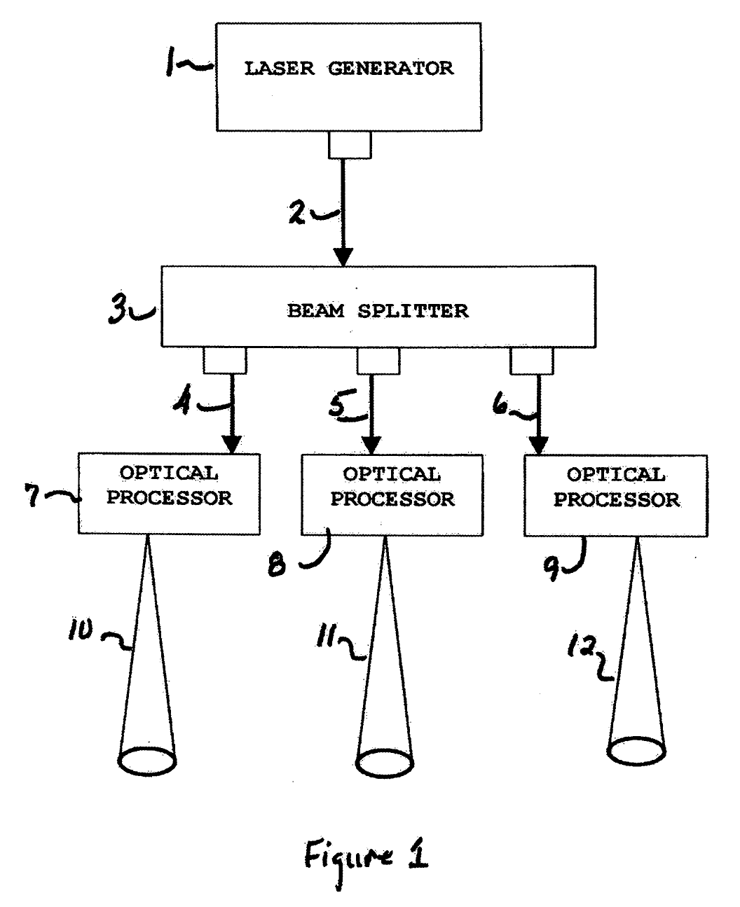

As shown in FIG. 1, the system of this invention is constructed having laser generator 1 which transmits an output laser beam 2 having an excess irradiance that is well above the optimum level, and thus capable of being divided. Beam splitter 3 receives output laser beam 2 and optically processes beam 2 to divide it into three beams 4-6 of a predetermined optimum irradiance. Beams 4-6 are further optically processed in processors 7-9 to produce annular beams 10-12. Annular beams 10-12 are applied to the target to perform a drilling operation that is substantially similar to laser trepanning.

In order to obtain the desired number of beams a laser generator is selected, according to one embodiment of this invention, that provides approximately four times the power required to drill a particular material Considering a material, such as Inconel 600, optimum irradiance requires only about ¼th of the full laser power available in existing industrial laser systems. The number of beams possible must take into account finite reflectivity and absorption losses in the beam-splitter sub-system 3. Allowing for finite losses, a system for obtaining sufficient power capable of drilling three holes essentially simultaneously is obtained using only one standard laser system 1.

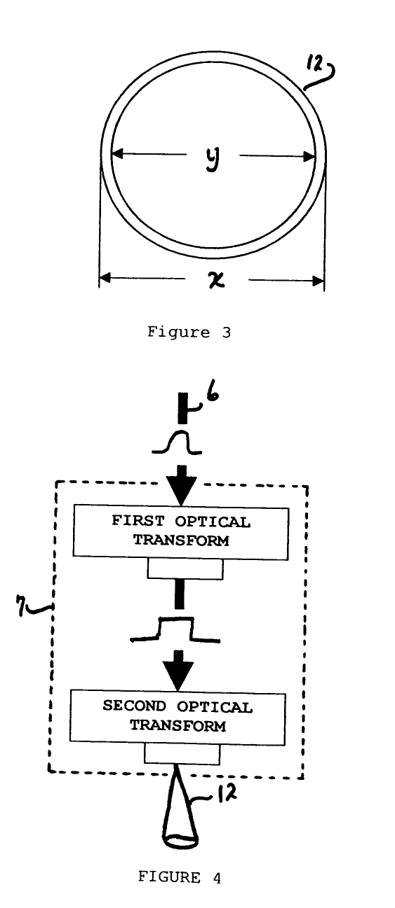

As shown in FIG. 4, the annular transform process is accomplish by first and second groups of optical lens 13 and 14. Each of the individual beams 10-12 are passed through first lens group 13 to transform the beam from a Gaussian distribution 16 to a uniform distribution 17, as illustrated in FIG. 4. A second lens group 14 transforms the beam into an annular irradiance distribution. The details of this transformation are discussed in the paper “Modeling of Gaussian to Annular Beam Shaping by Geometrical Optics”, OPTICAL ENGINEERING LETTERS, November 2004, by D. Zeng, W. Latham, and A Kar. Each OT-SS 7 (optical processor in FIG. 1) is constructed to process each of the output beams 4-6 of the optical beam-splitter sub-system 3 to generate a narrow annular shaped irradiance distribution 15, as shown in FIG. 3, having an outer diameter x and an inner diameter y. The outer diameter x of the annular irradiance distribution would be set to be equal to, or slightly smaller than the desired diameter of the hole to be drilled. The material within the inner diameter y will fall out as the drilling is complete. Each of the split beams are then transmitted to optical processor 7 where they are formed into the correct annular irradiance distribution 15.

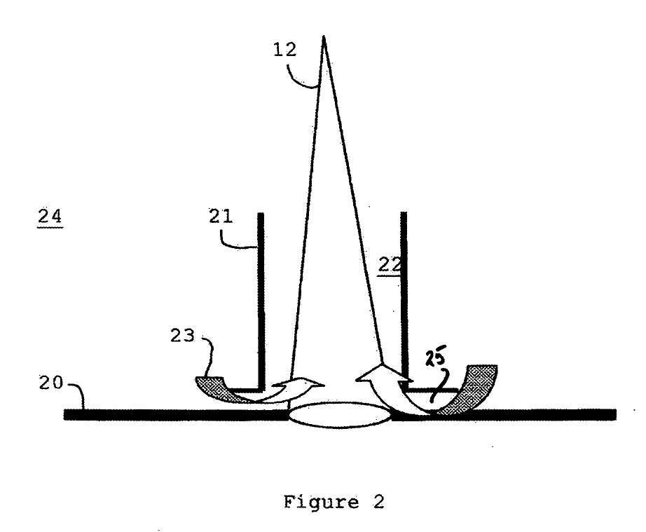

In a second embodiment of the invention, a shroud 21 is constructed to reduce the amount of recast material within and surrounding the drilled hole, the beams 10-12 are applied to target 20 through a shroud 21. Shroud 21 forms a confined space 22 that is capable of supporting a pressure that is reduced from the pressure of the ambient space 24. This allows the introduction of an inert gas such as Argon into the space 22 where drilling is occurring. A supply of Argon gas is provided to direct the inert gas, illustrated by arrow 23 in FIG. 2, through gap 25, that is provided between the shroud 21 and the target 20. The gap 25 may be adjustable to provide the desired flow velocity to reduce the amount of recast material condensing on the side-walls of the hole.

In this manner apparatus is provided to perform a drilling operation by generating a laser beam 12 having a predetermined power and subjecting the beam to an optical processor for dividing the single laser beam into multiple beams, for example beams 4, 5, and 6, as shown in FIG. 1. Laser beam 12 is generated at a power level selected to provide resultant beams 4-6 having sufficient irradiance levels capable of penetrating the target material. Because of losses in the transmittal and optical processing, it has been found that a number of commercially available laser generators have sufficient power to efficiently provide an array of 3 resultant beams. Each of the resultant beams 4-6 is transformed from a solid irradiance distribution to an annular irradiance distribution, as shown in FIG. 1. When applied to the target material, the annular beams drill holes slightly larger than the outside diameter x of the beam annulus, as shown in FIG. 3 in a pattern of 3 adjacent holes. By securing the target on an appropriate platform that is capable of transporting targets in x-y coordinates, and moving the target in a predetermined manner a large number of holes may be drilled in a precise, and efficient manner in a significantly reduced time.

It should be understood that the above description, with the referenced figures, is only intended to be illustrative of the invention. Various alternatives and modifications can be devised by those skilled in the art with out departing from the invention. Accordingly, the present invention is intended to embrace all such alternatives, modifications and variances which fall with the scope of the appended claims.

1. A system for drilling multiple holes in a workpiece, said workpiece constructed of a predetermined material comprising:
a laser generator for generating a laser beam having a power in excess of the power required to drill an individual hole in said material;
a beam splitter arranged to receive the generated laser beam and split said beam into multiple beams dependent on the excess power available;
multiple optical processors, each of said optical processors arranged to receive one of said split beams, said optical processors constructed to transform the received beam into a beam having an annular irradiance distribution;
a platform to support the workpiece so that the multiple annular beams are applied to the workpiece to allow each of said beams to drill a predetermined hole in said workpiece.

2. A system for drilling multiple holes in a workpiece, according to claim 1, wherein said laser generates approximately 4 times the power necessary and said beam splitter divides the generated beam into three beams.

3. A system for drilling multiple holes in a workpiece, according to claim 1, wherein said platform is constructed to move the workpiece with respect to said beams to allow each of said beams to drill multiple holes.

4. A system for drilling multiple holes in a workpiece, according to claim 1, further comprising a shroud constructed to form a confined space at the interface of the laser beam and workpiece, said confined space supporting a pressure that is reduced from the pressure of the ambient space outside of said shroud.

5. A system for drilling multiple holes in a workpiece, according to claim 4, further comprising a supply of inert gas connected to direct inert gas into said confined space.

6. A system for drilling multiple holes in a workpiece, according to claim 5, wherein said inert gas is Argon.

7. A method for drilling multiple holes in a workpiece, said workpiece constructed of a predetermined material comprising:
generating a laser beam having a power in excess of the power required to drill an individual hole in said material;
dividing said beam into multiple beams dependent on the excess power available;
transforming each of said multiple beams into a beam having an annular irradiance distribution;
supporting the workpiece so that the multiple annular beams are applied to the workpiece to allow each of said beams to drill a predetermined hole in said workpiece.

8. A method for drilling multiple holes in a workpiece, according to claim 7, wherein said laser generates approximately 4 times the power necessary and said beam splitter divides the generated beam into at least three beams.

9. A method for drilling multiple holes in a workpiece, according to claim 7, further comprising the step of moving the workpiece with respect to said beams to allow each of said beams to drill multiple holes.

10. A system for drilling multiple holes in a workpiece, according to claim 7, further comprising the step of constructing a confined space at the interface of the laser beam and workpiece, said confined space supporting a pressure that is reduced from the pressure of the ambient space outside of said shroud.

11. A system for drilling multiple holes in a workpiece, according to claim 10, further comprising the step of supplying inert gas into said confined space.

12. A system for drilling multiple holes in a workpiece, according to claim 11, wherein said inert gas is Argon.
